(19) United States
(12) Patent Application Publication
(10) Pub. No.: US 2025/0010286 A1
(43) Pub. Date: Jan. 9, 2025

(54) DEVICE FOR TESTING ANALYTE IN LIQUID SAMPLE

(71) Applicant: Zhejiang Orient Gene Biotech Co.,Ltd, Huzhou (CN)

(72) Inventors: Siyu LEI, Huzhou (CN); Jianqiu FANG, Huzhou (CN)

(21) Appl. No.: 18/346,625

(22) Filed: Jul. 3, 2023

(51) Int. Cl. B01L 3/00

(52) U.S. Cl. CPC B01L 3/5023; B01L 3/50273; B01L 2200/025; B01L 2200/16; B01L 2300/045; B01L 2300/069; B01L 2300/0825

(57) ABSTRACT

The invention provides a device and method for testing an analyte in a liquid sample, and the device includes a cover body, where the cover body includes a sample chamber for accommodating a sample collector and a liquid chamber containing a sample treatment liquid. Thus, when an amount of the sample collected by the sample chamber is insufficient, liquid in the liquid chamber is released to increase the volume of the liquid sample. Alternatively, during secondary testing, the liquid sample reduced or even the liquid sample dried is allowed to be redissolved, thereby facilitating the secondary testing.

### BACKGROUND OF THE INVENTION

### Field of the Invention

The invention relates to a device for collecting and testing a liquid sample, and in particular, to a device for collecting and testing an analyte in a liquid sample in the field of rapid diagnosis, such as a urine and saliva collection and testing device.

### Description of the Related Art

The following description is merely an introduction of some background general knowledge and does not constitute any limitation to the invention.

In the field of in vitro diagnosis (IVD), chromatographic techniques are often used to diagnose and detect diseases and other items. For example, immune colloidal gold test strip, dry chemical test strip, immunofluorescence test strip, and the like all react with reagents after samples are pretreated based on the chromatographic theory, so as to finally obtain diagnosis results reflecting whether patients suffer from diseases. The function process of the immunofluorescence test strip is that: after samples (whole blood, plasma, and the like) are dripped into a sample application pad, liquid flows to an absorbent filter paper; the samples are treated in the sample application pad to filtrate erythrocytes and remove interfering substances and the like; when flowing through a conjugate pad, the samples immunobind with antigens and antibodies and carry fluorophores; when flowing through a nitrocellulose membrane, the samples specifically bind with antigens and antibodies bound thereon in advance; and fluorophores gathered on a testing line and a control line can reflect test results, and other interfering substances unbound are absorbed by the absorbent filter paper. Fluorescence immunochromatography has been widely used in the field of POCT detection in recent years because of its simple operation, strong specificity, high sensitivity, and quantification. However, in recent decades, most of immunochromatographic test cards can be used for detection of a single item only in a form of a single card with a single test strip. However, with the development of medical technologies, multiple targets need to be detected at the same time during diagnosis of diseases for more accurate determination, such as myocardial 3-item joint examination and myocardial 5-item joint examination. Under some circumstances, it is necessary to detect the status of multiple organs at the same time to determine the diseases, such as cardiopulmonary 5-item joint examination.

At present, the test device for detecting the presence or absence of an analyte in sample is widely used in hospitals or homes, and these test devices for rapid diagnosis include one or more test strips, such as early pregnancy detection and drug abuse detection. Such test devices for rapid diagnosis are very convenient, and can obtain test results from the test strips after one minute or no at most about ten minutes. Drug detection is widely used by the drug control department, the Public Security Bureau, drug rehabilitation centers, physical examination centers, physical examination offices of national conscription, etc. The drug detection is diverse and frequent. Some detections are required to collect samples and then samples are detected in professional testing agencies or testing laboratories, and some detections need to be completed in the site in time, for example, roadsides, for example, persons who drive after drug use need to be tested on the spot (referred to as “Drug Driving”), to obtain the test results in time.

Sometimes, in case of an insufficient amount of samples collected, it is desirable to dilute the samples and then test them. Generally, the samples are tested after diluted alone, but it is always desirable to dilute them during collection and detection, as described in WO2021/019415A 2. For the sake of more convenient operation, it is still necessary to provide another solution.

### BRIEF SUMMARY OF THE INVENTION

In order to overcome defects in the prior art, a device for testing an analyte in a liquid sample is provided, and includes a cover body, where the cover body includes a sample chamber for accommodating a sample collector and a liquid chamber containing a sample treatment liquid.

In some embodiments, a liquid chamber is movably connected with the cover, or a liquid chamber can move on the cover body; during the movement of the liquid chamber, liquid therein can be released. In some embodiments, the liquid chamber has an immovable locking state and an immovable unlocking state on the cover body. In the locking state, the liquid chamber is fixed at a fixed position of the cover body; in the unlocking state, the liquid chamber can move relative to the cover body.

In some embodiments, the liquid chamber can be locked on the cover body by one locking element; and when the locking element moves (for example, departing from the cover body), the liquid chamber is in the locking state or the unlocking state. The so-called movement of the locking element may change the position of the locking element on the cover body, or may cause the locking element to move away from the cover body. In some embodiments, the locking element includes a snap ring, and the liquid chamber has a clamping slot for receiving the snap ring. When the clamping slot is combined with the snap ring, the liquid chamber is in the locking state; and when the slot is detached from the snap ring, the liquid chamber is in the unlocking state. In some embodiments, one end of the liquid chamber has one clamping slot with a groove, and the locking element has the snap ring and moves laterally, such that the snap ring is combined with the clamping slot. In some embodiments, the liquid chamber locked by the locking element is at a relatively high position; and when the locking element moves to unlock, the liquid chamber can move from the high position to a low position. The high position and the low position mentioned herein are relative to the longitudinal direction of the cover body. Alternatively, when the liquid chamber is located in a testing chamber, the high position and the low position mentioned herein are relative to a fixed piercing structure in the testing chamber, and the high position is distal to a piercing element and the low position is proximal to the piercing element.

In some embodiments, the cover body includes a docking area, and a hole is provided in the docking area and may allow the liquid chamber to pass through and expose a part of the liquid chamber. In some embodiments, the docking area has a plane, where a hole through which the liquid chamber passes is formed in the plane, one end of the liquid chamber is exposed and higher than the plane by a specified distance, and the hole is located in the plane. In some embodiments, the locking element fits with the part of the liquid chamber exposed, and the locking element includes the snap ring, while the liquid chamber exposed includes the clamping slot, and the snap ring fits with the clamping slot, such that the liquid chamber is fixed onto the cover body through the locking element and is at the high position. In some embodiments, the locking element is a card; the card includes the snap ring formed at a gap, and the snap ring fits with the part of the liquid chamber exposed out of the cover body, such that the liquid chamber is located at a fixed position on the cover body. In some embodiments, the clamping slot where the liquid chamber is exposed out is a clamping slot formed by a pressing portion at the top of the liquid chamber and a main body of the liquid chamber, and the clamping slot is similar to a neck of the liquid chamber and includes an apron and a groove around the top of the pressing portion, the snap ring of the locking element is locked at the groove or the neck, such that one end of the liquid chamber (a pressing end of the liquid chamber) is located at a position higher than a plane where the area is located by a specified distance and located at the fixing position together along with the cover body. In some embodiments, the liquid chamber and the cover body are located at a fixed position through the locking element, and at the same time, the locking element allows the liquid chamber to be higher than the plane by a specified distance and to be at the fixed position with the cover body.

In some embodiments, the locking element occupies the whole docking area, such that the locking element is located or parked on the docking area, and the liquid chamber is blocked or hidden by the locking element. Thus, only when the locking element moves away from or is detached from the docking area, the liquid chamber is exposed. In some embodiments, when the locking element moves away from or is detached from the locking area, the liquid chamber is in the unlocking state and is movable, for example, the liquid chamber is pushed to move from the high position to the low position, or the liquid chamber is pushed to enter the testing chamber. In some embodiments, a snap ring on the locking element further includes a covering face, where the snap ring is located under the covering face; a projection of the covering face causes the snap ring to be located in a projection area; to be specific, with the covering face being parallel to the snap ring on the card, the card cannot be seen when the covering face is looked down; alternatively, the covering face is allowed to cover the top of the liquid chamber and combined with the docking area, so that the locking element covers or wraps the liquid chamber on the entire plane to hide the liquid chamber.

In some embodiments, the cover body has two faces, one of the faces is a face facing toward the interior of the testing chamber and can also be called a back face, and the other thereof is a face opposite the other face of the testing chamber and can also be called a front face. In some embodiments, an inlet of the sample chamber is located at the front face of the cover body; and in some embodiments, a surface where the inlet of the sample chamber is located is higher than the plane of the docking area. Therefore, the docking area is similar to a step structure, for example, an L-shaped structure. The locking element allows the liquid chamber to be at a locking position combined with the cover body and covers the entire liquid chamber exposed, thereby hiding the liquid chamber. In addition, the locking element needs to be unlocked or locked, the locking position thereof on the docking area is also at a fixed position determined. In some embodiments, when the locking element is located in the docking area, the locking element and the cover body are of an integral structure, and at this time, only the inlet of the sample chamber is retained. The so-called “hide” means that the structure of the locking element is combined with the structure of the docking area on the cover body, such that the external part of the liquid chamber (at least the part higher than the plane of the docking area) is wrapped and the liquid chamber can be seen from the outside. If the test device includes the testing chamber, the part of the liquid chamber located below the plane is located in the testing chamber, and is unlikely to be seen. Therefore, from the outside, it seems that the testing device does not include the liquid chamber, and the main purpose of hiding is to prevent deliberate manual operation to achieve early detection. For example, subjects who are collected for the samples detect such samples by themselves instead of professional personnel, so it is possible not to find out fake samples.

In some embodiments, when the locking element is unlocked or departs from the docking area, the liquid chamber can move towards the back of the cover body. In some embodiments, the liquid chamber can depart from the docking area along the direction of the back of the cover body, or the liquid chamber can move from the high position to the low position on the docking area. In some embodiments, when the cover body covers the testing chamber, the liquid chamber can move into the testing chamber. In some embodiments, a testing element for testing an analyte in a liquid sample and a piercing element are provided in the testing chamber. The liquid chamber is not pierced when locked on the cover body by the locking element; and when the liquid chamber is unlocked and moves from the high position to the low position or departures from the docking area, or after that, the piercing element pierces the liquid chamber, thereby releasing the sample treatment liquid into the testing chamber. In some embodiments, the liquid chamber at the locking position is distal to the piercing element. The liquid chamber is proximal to the piercing element or pierced by the piercing element when moving from the high position to the low position—in the unlocking state. In some embodiments, the liquid chamber includes a reagent solution for sample treatment. In some embodiments, a sealing film liquid chamber includes a sealing film easy to pierce; and the sealing film is easy to pierce by a sharp piercing structure.

In some embodiments, the liquid chamber includes a first locking position and a second unlocking position relative to the cover body. In some embodiments, when the liquid chamber is located at the first locking position, liquid in the liquid chamber is not released; and when the liquid chamber is located at the second unlocking position, the liquid in the liquid chamber is capable of being released. In some embodiments, the liquid chamber is located at a locking position and locked on the cover body by the locking element. In some embodiments, the locking element includes a limiting structure capable of limiting movement of the liquid chamber; and when the limiting structure is detached from the liquid chamber, the liquid chamber changes from a locking state to an unlocking state. In some embodiments, the liquid chamber in the unlocking state is movable relative to the cover body. In some embodiments, the movement includes downward movement relative to the cover body.

In some embodiments, a channel is provided in the sample chamber; when the sample collector is inserted into the sample chamber, an absorption element of the sample collector is squeezed, whereby releasing the liquid sample into the sample chamber; and then the liquid flows out of the sample chamber along the channel. In some embodiments, a platform forming a bottom is provided at the bottom of the sample chamber, and the absorption element of the sample collector is in contact with the bottom and is squeezed, whereby releasing the liquid sample on the absorption element. In some embodiments, a channel extends downward from the bottom of the sample chamber, through which the squeezed or released liquid sample flows out. In some embodiments, the cover body is used to cover the testing chamber having the testing element; and when the cover body is closed, the liquid sample flowing out of the sample chamber enters the testing chamber. Alternatively, the sample chamber and the liquid chamber extend outward from the cover body in a same direction. In some embodiments, the liquid chamber is movable relative to the cover body, while the sample chamber and the cover body are integrated into a fixed integral structure and unable to move relative to each other. Thus, when the liquid chamber is located in the testing chamber, the position thereof in the testing chamber is constant and the liquid chamber in the testing chamber is movable, and such movement is controlled by the locking element.

In some embodiments, the device further includes a testing chamber having a testing element, the cover body covers an opening of the testing chamber, and the sample chamber and the liquid chamber are located in the testing chamber. In some embodiments, the testing chamber includes a piercing element capable of piercing the liquid chamber; and when the liquid chamber moves inward the testing chamber relative to the cover body, the piercing element pierces the liquid chamber and enters therein, such that the liquid in the liquid chamber is forced to flow into the testing chamber. In some embodiments, the piercing element is provided with a sharp piercing needle and a base connected with the piercing needle, and a diameter of the base is equivalent to that of the liquid chamber. In some embodiments, the testing chamber includes a carrier for carrying the testing element, and the carrier is provided with a groove for fixing the testing element.

In some embodiments, a hole communicating with atmosphere is provided in the cover body, and a channel extending towards a direction where the sample chamber is located is provided in the hole; alternatively, the extended channel, the liquid chamber, and the sample chamber share an extension direction, or all extend from the cover body to the back of the cover body, or all extend into the testing chamber. The arrangement of the hole communicating with atmosphere is to keep the testing chamber communicate with the outside. Thus, when the treatment liquid in the liquid chamber is pierced, such treatment liquid is easy to flow into the testing chamber; in addition, the liquid sample collected by the sample chamber is also easy to flow into the testing chamber.

In some embodiments, the invention provides a method for testing an analyte in a liquid sample, and the method includes: providing a device, where the device includes a cover body and a testing chamber, and the cover body includes a sample chamber for accommodating a sample collector and a liquid chamber containing a sample treatment liquid, the liquid chamber has a locking state and an unlocking state, and the testing chamber includes a testing element capable of testing an analyte in a sample; collecting a liquid sample with a collector, inserting the liquid sample into the sample chamber, and releasing the liquid chamber to the sample chamber, where the liquid sample in the sample chamber flows into the testing chamber and contacts with the testing element; allowing the liquid chamber to be at the unlocking state, pushing the liquid sample chamber into the testing chamber, and releasing the treatment liquid into the testing chamber. In some embodiments, a piercing element is arranged in the testing chamber, such that the liquid chamber is in contact with the piercing element, and the piercing element pierces the liquid chamber to release liquid. In some embodiments, the piercing element is allowed to enter the liquid chamber, such that the liquid chamber is forced to release the treatment solution into the testing chamber.

In some embodiments, an unlocking timing is also a unique feature of the invention. This is mainly because, during an initial test, some test results are found to be in an interval unable to be determined, for example, negative interval or positive interval, final results are unable to be determined. This is an inherent problem of immunoassay. In this case, it is necessary to deliver test samples to more advanced and precise test devices for validation test. If an amount of the sample is relatively small, water in a primary sample will evaporate or even dry during transportation. In this case, when the validation test is performed, the locking element is enabled; after unlocking, the treatment liquid in the liquid chamber is pierced into the testing chamber to dissolve the dry analyte, and the samples are taken for secondary testing. This solves a disadvantage that the reduced or dried samples during transportation cannot be performed for secondary validation test.

In some embodiments, in all the above-mentioned ways, the liquid sample may be blood, urine, saliva, sweat, or the like.

A method for testing an analyte in a liquid sample is provided and includes:
providing a device, where the device includes a cover body and a testing chamber, and the cover body includes a sample chamber for accommodating a sample collector and a liquid chamber containing a sample treatment liquid, the liquid chamber has a locking state and an unlocking state, and the testing chamber includes a testing element capable of testing an analyte in a sample;
collecting a liquid sample with a collector, inserting the liquid sample into the sample chamber, and releasing the liquid chamber to the sample chamber;
where the liquid sample in the sample chamber flows into the testing chamber and contacts with the testing element;
allowing the liquid chamber to be at the unlocking state, pushing the liquid sample chamber into the testing chamber, and releasing the treatment liquid into the testing chamber.

### Beneficial Effect

In the invention, the treatment liquid is combined with the liquid sample. If an amount of the liquid sample is relatively small, the treatment liquid may be mixed with the liquid sample. If the amount of the liquid sample is sufficient, the treatment liquid may not be used and multiple choices may be given. In addition, the treatment liquid of the invention is separately provided, instead of directly contacting the collector. After the initial test, if the test results are suspected or undetermined, the liquid samples need to be performed for secondary validation test, and usually need to be transported to a professional laboratory by a long distance; in this case, samples in the testing chamber are likely to evaporate and become less or even unavailable (water is evaporated), and the treatment liquid may enter the testing chamber to dissolve the remaining samples or analytes, forming new liquid samples, which facilitates sampling for the secondary validation test.

### BRIEF DESCRIPTION OF THE DRAWINGS

FIG. 1 is a structural schematic diagram of a testing element according to an embodiment of the invention.

FIG. 2 is a schematic diagram showing a three-dimensional structure of a testing element according to an embodiment of the invention.

FIG. 3 is a three-dimensional schematic diagram of a test device completely assembled according to the invention.

FIG. 4 is a schematic diagram showing an exploded structure of a test device according to the invention.

FIG. 5 is schematic diagram showing a three-dimensional structure of a cover body (without locking element).

FIG. 6 is a schematic diagram showing a cross-sectional structure of a cover body (with locking element).

FIG. 7A is a schematic diagram showing a cross-sectional structure of a cover body along A-A of FIG. 7B (a locking element is detached from the cover body).

FIG. 7B is a top view of a cover body.

FIG. 8 is a schematic diagram showing a three-dimensional structure of a cover body (without liquid chamber).

FIG. 9A is a schematic diagram showing a three-dimensional structure of a locking element.

FIG. 9B is a top view of a locking element and a schematic diagram showing a three-dimensional structure thereof along A-A′ cross section.

FIG. 10A is a schematic diagram showing a three-dimensional structure of a testing chamber.

FIG. 10B is a top view of a testing chamber.

FIG. 11 is a schematic diagram showing a cross-sectional structure of a testing chamber.

FIG. 12 is a schematic diagram showing a cross-sectional structure of a combination of a cover body and a testing chamber, where a collector is located in a sample chamber and a liquid chamber is located at a high position and an unlocking state.

FIG. 13A is a top view of a cover body that covers the test chamber as a test device.

FIG. 13 B is a schematic diagram showing a cross-sectional structure of a combination of a cover body and a testing chamber, where a collector is located in a sample chamber and a liquid chamber is located at a lower position and an unlocking state.

### DETAILED DESCRIPTION OF THE INVENTION

The following further describes the structures involved in the invention or the technical terms used therein. Unless otherwise specified, they shall be understood and explained according to the general terms commonly used in the prior art.

### Detection

Detection means assaying or testing presence or absence of a substance or material, including but not limited to, chemical substance, organic compound, inorganic compound, metabolite, drug, drug metabolite, organic tissue, metabolite of organic tissue, nucleic acid, protein or polymer. In addition, detection means that the amount of a substance or material is tested. Further, assay also means immunoassay, chemical assay, enzyme assay, and the like.

### Sample

The samples detected by the test device of the invention include biological liquid (for example, case liquid or clinical sample). Liquid samples or liquid specimens may be derived from solid or semi-solid samples, including feces, biological tissues and food samples. The solid or semi-solid samples may be converted to liquid samples by any appropriate methods, such as mixing, mashing, macerating, incubating, dissolving, or digesting the solid samples by enzymolysis in suitable solutions, such as water, phosphate solutions, or other buffer solutions. “Biological samples” include animal, plant, and food derived samples, including, for example, human or animal derived urine, saliva, blood and components thereof, spinal fluid, vaginal secretions, sperm, feces, sweat, secretions, tissues, organs, tumors, cultures of tissues and organs, cell cultures, and media. Preferably, the biological sample is urine, and preferably, the biological sample is saliva. Food samples include food processed materials, final products, meat, cheese, wine, milk, and drinking water. Plant samples include samples derived from any plants, plant tissues, plant cell cultures, and media. “Environmental samples” include samples derived from the environment (e.g., liquid samples from lakes or other bodies of water, sewage samples, earthen samples, groundwater, seawater, and waste liquid samples). The environmental sample may further include sewage or other waste water.

An appropriate test device according to the present invention can be used to detect any analyte. Preferably, the test device of the present invention is used to detect small drug molecules in saliva and urine. Of course, the samples detected by the test device of the present invention may be any samples of the above forms, regardless of being solid or liquid at the beginning, provided that these liquids or liquid samples can be absorbed by the sample application area of the testing element. Generally, the sample application area is made of a water absorbent material, and liquid samples or liquid specimens can be absorbed by the capillary or other characteristics of the material of an absorption element, such that the liquid sample can flow in the sample application area. The material of the liquid sample application area may be any material capable of absorbing liquid, such as sponge, filter paper, polyester fiber, gel, non-woven fabric, cotton, polyester film, and yarn. Of course, the liquid sample application area may be made of a water absorbent material or a non-water absorbent material. However, the absorption element is provided with holes, screw threads, and caves on which the samples can be collected. Generally, the samples are solid or semi-solid samples, and filled between screw threads and in the holes or caves for collection. Of course, optionally, the sample application area may be composed of some non-absorbent fibers and hairs, and these materials are used to scrape a solid, semi-solid or liquid sample, such that these samples can be retained on the sample application area. If detection is needed, a buffer solution is applied to the sample application area to dissolve the sample, such that the dissolved sample flows on the testing element or the detection element.

### Downstream and Upstream

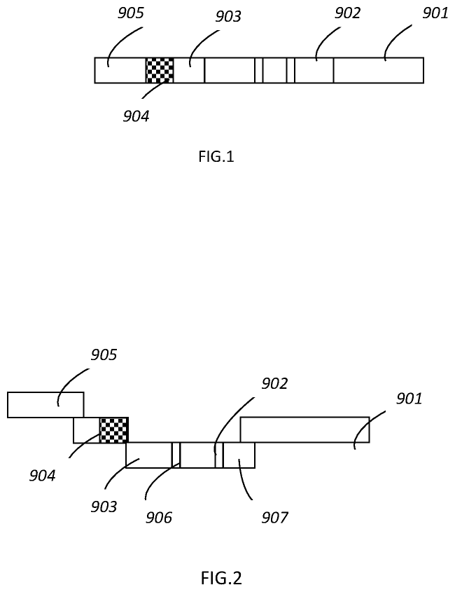

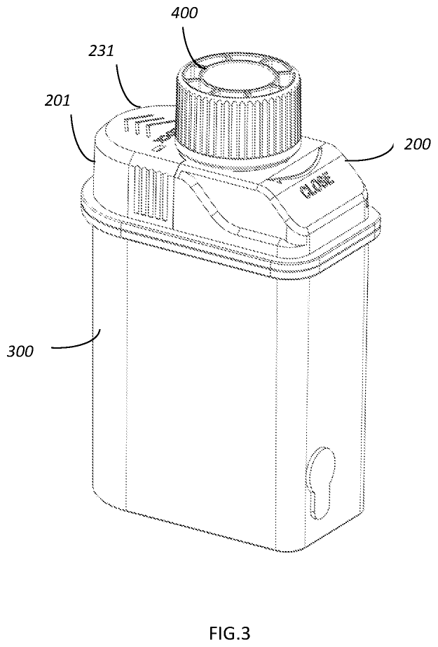

Downstream or upstream is divided according to a flow direction of a liquid, generally, a liquid or fluid flows to a downstream area from an upstream area. The downstream area receives the liquid from the upstream area, and a liquid also may flow to a downstream area along an upstream area. Here, downstream or upstream is generally divided according to a flow direction of a liquid, for example, on some materials where capillary force is utilized to promote the flow of a liquid, a liquid may overcome gravity to flow towards an opposite direction to the gravity; and in this case, downstream or upstream is divided according to a flow direction of the liquid. For example, in the test device of the invention, after a diversion element receives the liquid sample, fluid can flow from the diversion element to a sample application area or a sample application pad of two testing elements, and then liquid flowing to the sample application pad flows to a downstream label pad and is mixed with the marked label; and the mixture flows to a downstream testing pad through a transition pad, where a testing area on the testing pad is located upstream of a test result control area, such that the mixture finally flows to an absorption pad on a downstream absorption area. The testing area may be a polyester fiber film, and the diversion element may be a glass fiber, a polyester chip, and a polyester film. In this case, the diversion element is located at the upstream of the label area of the testing element. The specific structure of the testing element is a structure 20 as shown in FIG. 1 and FIG. 2. Liquid on a part of the sample application pad flows mainly by a capillary force.

### Gas Flow or Liquid Flow

Gas flow or liquid flow means that liquid or gas can flow from one place to another place. In a flow process, the liquid or gas may pass through some physical structures to play a guiding role. The “passing through some physical structures” here means that liquid passes through the surface of these physical structures or their internal space and flows to another place passively or actively, where passivity is usually caused by external forces, such as flow under the capillary action and the action of air pressure. The flow here may also be a flow due to self-action (gravity or pressure) of the liquid or gas, and also may be a passive flow. The fluid under the action of air pressure may be a forward flow, or also a reverse flow; or a fluid is urged to flow to another position from a position under the action of air pressure. Here, the flow does not mean that a liquid or a gas is necessarily present, but indicates a relationship or state between two objects under some circumstances. In case of presence of liquid, it can flow from one object to another. Here it means the state in which two objects are connected. In contrast, if there is no gas flow or liquid flow state between two objects, and liquid exists in or above one object but is unable to flow into or on another object, it is a non-flow, non-liquid or non-gas flow state.

### Testing Element

The “testing element” used herein refers to an element that can be used to detect whether a fluid sample or a fluid specimen (a liquid sample or a liquid specimen) contains an interested analyte. Such testing can be based on any technical principles, such as immunology, chemistry, electricity, optics, molecular science, nucleic acids, and physics. The testing element can be a lateral flow test strip that can detect a variety of analytes. Of course, other suitable testing elements can also be used in the present invention. In the invention, the testing element and the “lateral flow testing element, or test strip” can be used interchangeably, indicating same meanings.

Various testing elements can be combined for use in the invention. One form of the testing elements is a test strip. The test strips used for analyzing the analyte (such as drugs or metabolites that show physical conditions) in samples can be of various forms such as immunoassay or chemical analysis. The analysis mode of non-competition law or competition law can be applied for test strips. A test strip generally contains a water absorbent material that has a sample application area, a reagent area, and a testing area. Fluid or liquid samples are added to the sample application area and flow to the reagent area under the capillary action. If analyte exists in the reagent area, samples will bind to the reagent. Then, samples continue to flow to the testing area. Other reagents such as molecules that specifically bind to analyte are immobilized on the testing area. These reagents react with the analyte (if any) in the sample and bind to the analyte in this area, or bind to a reagent in the reagent area. Label used to display the detection signal exists in the reagent area or the detached label area.

Typical non-competition law analysis mode: if a sample contains analyte, a signal will be generated; and if not, no signal will be generated. Competition law: if no analyte exists in the sample, a signal will be generated; and if analyte exists, no signal will be generated.

The testing element can be a test strip, which can be water absorbent material or non-water absorbent material. The test strip can contain several materials used for delivery of liquid samples. One material of the test strip can cover the other material thereof. For example, the filter paper covers the nitrocellulose membrane. One or more materials may be used in one area of the test strip, and one or more other different materials may be used in the other area thereof. The test strip can stick to a certain support or on a hard surface for improving the strength of holding the test strip.

Analyte is detected through a signal generating system. For example, one or more enzymes that specifically react with this analyte is or are used, and the above method of fixing a specific binding substance on the test strip is used to fix the combination of one or more signal generating systems in the analyte testing area of the test strip. The substance that generates a signal can be in the sample application area, the reagent area or the testing area, or on the entire test strip, and one or more materials of the test strip can be filled with this substance. The solution containing a signifier is added onto the surface of the test strip, or one or more materials of the test strip is or are immersed in a signifier-containing solution. The test strip containing the signifier solution is made dry.

Various areas of the test paper can be disposed as follows: sample application area 905, label area 904, and testing area 902, where the testing area includes a test result area 906 and a test result control area 907. The control area is located behind or downstream of the testing area. All areas can be disposed on a test paper that is only made of one material. Alternatively, different areas may be made of different materials. Each area can be in direct contact with the liquid sample, or different areas are arranged according to the flow direction of liquid sample; and a tail end of each area is connected and in overlapped with the front end of the other area. Materials used can be those with good water absorption such as filter papers, glass fibers or nitrocellulose membranes. The test strip can also be in other forms.

The nitrocellulose membrane test strip is commonly used, that is, the testing area includes a nitrocellulose membrane (NC) on which a specific binding molecule is immobilized to display the test result; and other test strips such as cellulose acetate membrane or nylon membrane test strips can also be used. For example, test strips and similar devices with test strips disclosed in the following patents: U.S. Pat. Nos. 4,857,453; 5,073,484; 5,119,831; 5,185,127; 5,275,785; 5,416,000; 5,504,013; 5,602,040; 5,622,871; 5,654,162; 5,656,503; 5,686,315; 5,766,961; 5,770,460; 5,916,815; 5,976,895; 6,248,598; 6,140,136; 6,187,269; 6,187,598; 6,228,660; 6,235,241; 6,306,642; 6,352,862; 6,372,515; 6,379,620, and 6,403,383. The test strips and similar device with test strips disclosed in the above patents may be applied to the testing element or test device of the invention for the detection of an analyte, for example, the detection of an analyte in a sample.

Test strips used in the invention may be commonly referred as lateral flow test strips. The specific structure and detection principle of the test strips are well known to a person skilled in the art in the prior art. A common test strip (as shown in FIG. 1-FIG. 2) includes a sample application area 905, a label area 904, and a testing area 902; the sample collection area includes a sample receiving pad or a sample application pad; and the label area includes a label pad. The test strip may further include a water absorption area 901 to absorb the liquid sample from the nitrocellulose membrane and the water absorption area may include a water absorption pad. In some embodiments, the label area includes color particles conjugated with antibodies, and the color particles may be latex particles, gold particles, or dyes. The testing area 902 includes necessary chemical substances, such as immunoreagents or enzyme chemical reagents, all which can detect presence or absence of an analyte. The nitrocellulose membrane test strip is commonly used, that is, the testing area 902 includes a nitrocellulose membrane, and an area 906 (T-line) on which a specific binding molecule is immobilized to display the test result; and other test strips such as cellulose acetate membrane or nylon membrane test strips can also be used. Of course, in the downstream of the testing area, there may also be a test result control area 907 (C-line); generally, test strips appear on the test result control area and the testing area in the form of a horizontal line, namely, a test line or a control line. Such test strips are conventional. Of course, they can also be other types of test strips for detection under the capillary action. In addition, there are dry chemical reagent components on common test strips, for example, an immobilized antibody or other reagents. When the test strip contacts liquid, the liquid flows along the test strip under the capillary action, and the dry reagent components are dissolved in the liquid and treated in a next area, and the dry reagents react in the area for necessary detection. The liquid flow mainly relies on the capillary action. Here, all of the test strips can be applied to the test device of the invention or can be disposed in contact with the liquid samples in a detection chamber or used to detect the presence or absence of analyte in the liquid samples that enter a detection chamber, or the quantity thereof.

In addition to the foregoing test strip or lateral flow test strip which is used to contact with the liquid sample to test whether the liquid samples contain analytes. The testing element of the present invention may be used as a test device by itself to detect an analyte in a sample. Therefore, the test device here is equal to a testing element. For example, after mixed with a treatment liquid, the liquid sample is detected with a testing element directly, specifically described as follows: When a receiving device is described to treat a liquid sample, the testing element may be used for detection alone.

### Analyte

Examples that can use an analyte related to the invention include some small-molecule substances, including drugs (such as drug of abuse). “Drug of Abuse” (DOA) refers to using a drug (playing a role of paralyzing the nerves usually) not directed to a medical purpose. Abuse of these drugs will lead to physical and mental damage, dependency, addiction and/or death. Examples of drug abuse include cocaine; amphetamine (AMP) (e.g., Black Beauty, white amphetamine tablets, dexamphetamine, dexamphetamine tablets, and Beans); methamphetamine (MET) (crank, meth, crystal and speed); barbiturate (BAR) (such as Valium, Roche Pharmaceuticals, Nutley, and New Jersey); sedatives (i.e., a sleep aid medicine); lysergic acid diethylamine (LSD); inhibitors (downers, goofballs, barbs, blue devils, yellow jackets, and methaqualone); tricyclic antidepressants (TCAs, i.e. imipramine, amitriptyline, and doxepin); dimethylenedioxymethylaniline (MDMA); phencyclidine (PCP); tetrahydrocannabinol (THC, pot, dope, hash, weed, etc.); opiates (i.e., morphine (MOP) or opium, cocaine (COC), heroin, and hydroxydihydrocodeinone); and anxiolytic drugs and sedative-hypnotic drugs. The anxiolytic drugs are mainly used for relieving anxiety, tension, and fear, and stabilizing emotion, and have hypnotic and sedative effects. The anxiolytic drugs include benzodiazepines (BZO), atypical benzodiazepines (BZ), fused dinitrogen NB23C, benzodiazepines, ligands of BZ receptors, open-ring BZ, diphenylmethane derivatives, piperazine carboxylates, piperidine carboxylates, quinazolinones, thiazine and thiazole derivatives, other heterocycles, imidazole-type sedative/analgesic drugs (e.g., oxycodone (OXY) and methadone (MTD)), propylene glycol derivatives-carbamates, aliphatic compounds, anthracene derivatives, and the like. The detection device of the present disclosure may also be used for detecting drugs belonging to a medical use but easy to be taken excessively, such as tricyclic antidepressants (imipramine or analogues) and acetaminophen. These drugs are metabolized into micromolecular substances after absorbed by human body. These micromolecular substances exist in blood, urine, saliva, sweat and other body fluids or in some body fluids.

For example, the analyte detected by the pre invention includes but is not limited to creatinine, bilirubin, nitrite, (nonspecific) proteins, hormones (for example, human chorionic gonadotropin, progesterone, follicle-stimulating hormone, etc.), blood, leucocytes, sugar, heavy metals or toxins, bacterial substances (such as proteins or carbohydrates against specific bacteria, for example, Escherichia coli 0157:H7, Staphylococcus, Salmonella, Fusiformis, Campylobacter genus, L. monocytogenes, Vibrio, or Bacillus cereus) and substances related with physiological features in a urine sample, such as pH and specific gravity. Chemical analysis of any other clinical urine may be performed by lateral flow test in combination with the device of the invention. Such chemical analysis can be also used to detect the presence of virus antigens, such as COVID-19 antigen and influenza antigen.

### Carrier Including Testing Element

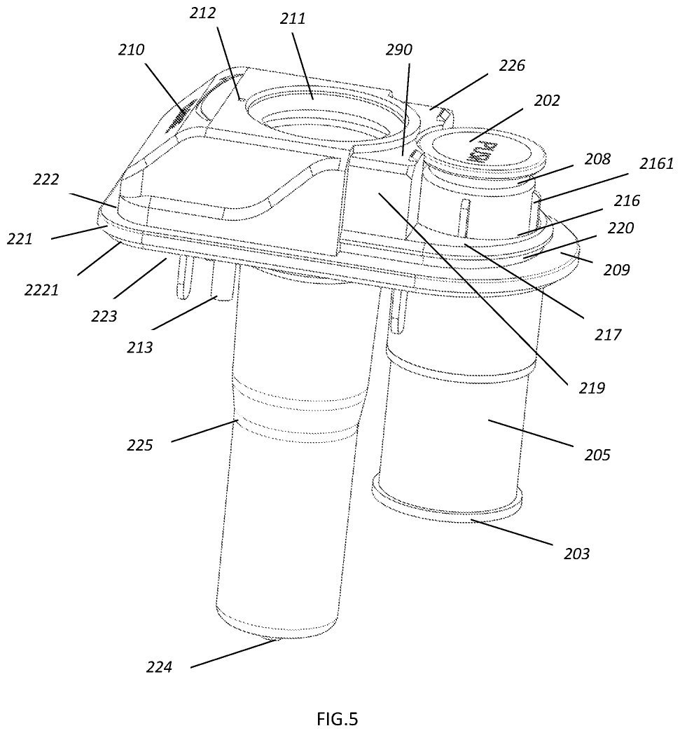

In some specific embodiments, the testing element may be also disposed on some carrier elements; and the carrier elements include the testing element to complete the detection and assay of the analytes in liquid samples. Therefore, in some embodiments, the test device includes a carrier, and the carrier is provided with a testing element. In some embodiments, the carrier of the invention is a housing used for bearing or accommodating the testing element; the carrier element does not participate in the detection directly by itself, but serves as a carrier or housing used for bearing or accommodating the testing element. For example, as shown in FIG. 4, two carriers 311, 301 are provided are provided, where grooves are respectively arranged in the two carriers and are configured to accommodate the testing element 20. One of the carriers can be provided with a plurality of grooves 307, 308, 309, 310, and each of the grooves is provided with one testing element. Generally, the sample application area of the testing element is located at one end of the groove having an opening. After the testing element is arranged in the groove, a transparent film covers the surface of the carrier 301, and then the carrier 301 is inserted into a testing chamber. The testing chamber has two faces 312, 313 opposite a plane. The carrier is inserted into the testing chamber and rests on the surface of the plane, while the face having the testing element rests on the plane, such that test results on the testing element can be read through a transparent surface of the testing chamber during the test.

In some embodiments, each of the grooves in the carrier 301 has a protruding structure at one end thereof, and the protruding structure allows the testing element to be fixed in the groove. Generally, the convex structure is the position of the water absorption pad stuck on the water absorption area of the testing element. In some embodiments, the testing chamber has an opening 306 at one end thereof, and is enclosed by a bottom and a side wall 312. The opening 306 can be sealed by a cover body, such that a sealing space is formed in the testing chamber and internally provided with the carrier, and one or more testing elements are arranged on the carrier and can test the analyte in the sample. A protruding structure is provided at the middle position of the bottom of the testing chamber. The bottom of the protruding structure and the bottom of the testing chamber with flat side walls 312, 313 form a narrow slit or a narrow groove. The carriers 301, 311 are arranged on the bottom of the narrow groove, and a tail end of the sample application area of the testing element is proximal to the bottom of the narrow groove. When entering the testing chamber, the liquid sample can flow into the narrow slit, and a liquid sample is present in the narrow slit to contact the bottom of the test strip. Liquid especially on an end portion of the sample application area of the test strip flows on the test strip under the capillary action, thereby testing the analyte in the liquid sample. The following further gives a detailed explanation and description with reference to the specific embodiments.

### Testing Chamber Including Testing Element

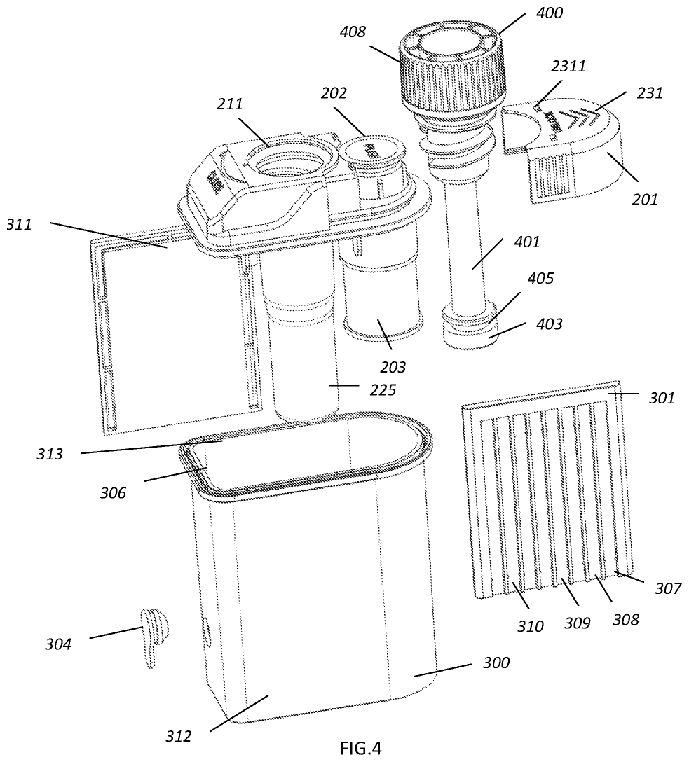

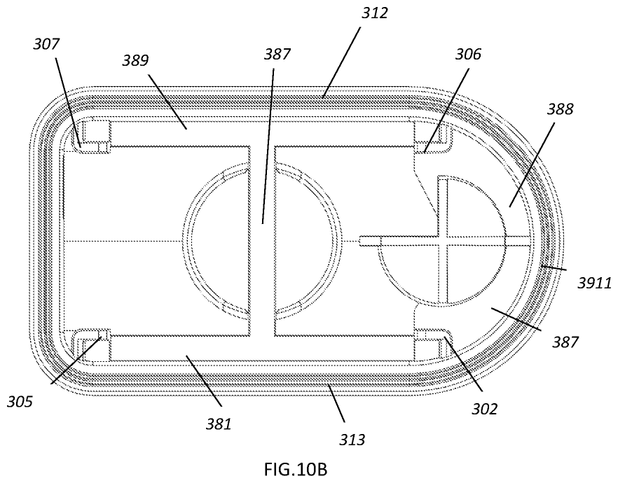

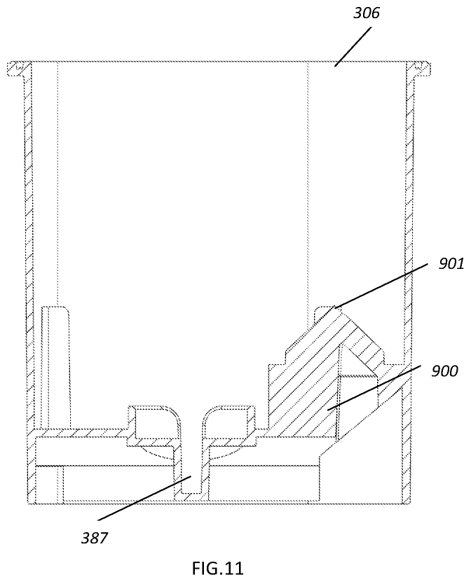

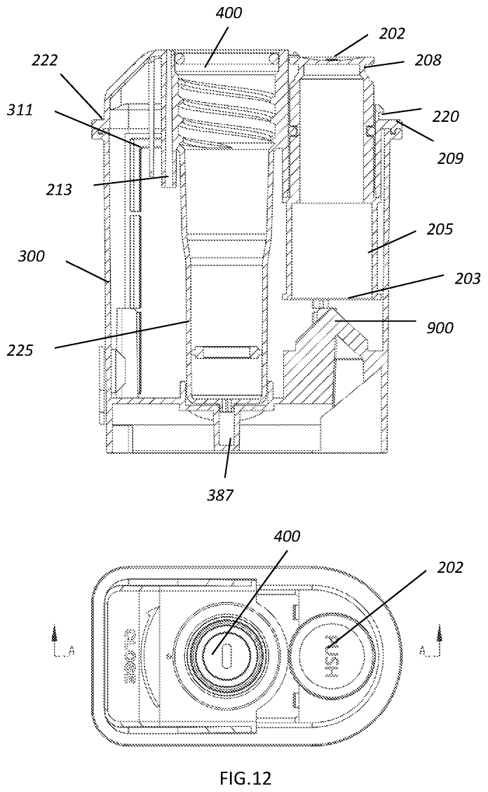

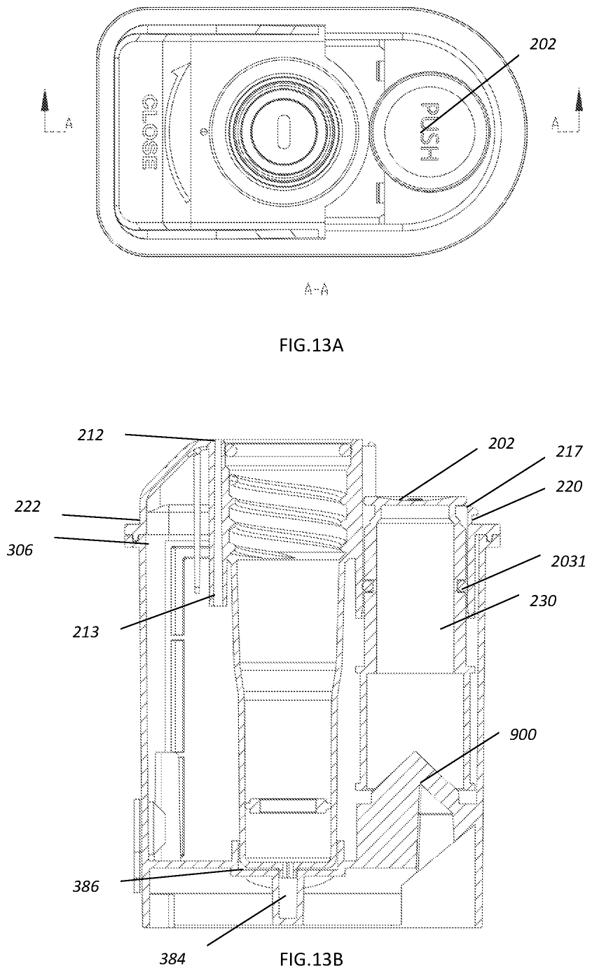

The invention provides a testing chamber 300, and the testing chamber includes a testing element, and the testing element may be provided in one or in plurality. In some embodiments, the testing element is arranged on a carrier, and the carrier includes a plurality of grooves, each of the grooves is provided with a test strip, and the carrier is located in the testing chamber. As shown in FIG. 3, FIG. 10, and FIG. 11, the testing chamber includes an opening 306 and a chamber enclosed by a bottom of the testing chamber and surrounding side walls thereof. A protruding structure 382 is provided at the bottom of the testing chamber, grooves or channels 381, 3811 are formed between the protruding structure 382 and two opposite flat side walls 312, 313, and the channels are formed in the bottom of the respective flat side wall. A groove or channel 387 is also formed in the protruding structure, and the channel communicates with the channels 381, 3881 below the side walls, such that fluid communication can be formed between the channels, and fluid can flow between the channels. A circular table is arranged respectively on protruding faces, and the channel 387 is formed between the protruding faces, and divides the circular table into two parts 385, 386. The protruding faces are used to accommodate the bottom 255 of the sample chamber. The bottom 255 of the sample chamber is allowed to be in contact with the protruding faces385, 386, and an enclosure is formed around the protruding faces and encircles the bottom of the sample chamber, such that the sample chamber is in a fixed position in the testing chamber (FIG. 12). At the same time, a channel 224 at the bottom of the sample chamber is located in the channel 387 between the protruding faces385, 386; the liquid sample in the sample chamber directly flows into the channel 387 when flowing out of the channel 224 at the bottom 255 of the sample chamber, such that the liquid sample can respectively flow into the grooves or channels 381, 3811 at the bottom of the testing chamber; the bottoms of two grooves are respectively provided with a sample application area of the testing element, or the carrier is respectively provided on the two grooves, an end portion of the sample application area of the testing element on the carrier is located at the bottom of the groove, such that the liquid sample in the groove contacts with the testing element, thereby implementing detection of an analyte in the liquid sample.

A piercing element 900 is provided on a side of the bottom of the testing chamber, for example, inside a position proximal to the side wall 391. The piercing element is provided with a sharp piercing needle 901 and a base 909 on which the piercing needle is arranged; the base is located on an inner side of the testing chamber; four lateral diaphragms 903, 904, 905, 906 are provided on the base to divide it into four parts; when the piercing needle pierces a membrane at the bottom of the liquid chamber, the lateral diaphragm plays a diversion role and diverts the treatment liquid into the bottom of the testing chamber; in addition, the lateral diaphragms intersects with a point at the top of the base 909, and the point forms the piercing needle. In some embodiments, the bottom of the base is located on an inclined plane 387; the inclined plane is distributed on two sides of the base 909; and the inclined plane 387 of the base proximal to the side wall 312 of the plane and an inclined plane 388 proximal to the side wall 313 of the plane extend onto the channel. As shown in FIG. 10, in order to fix the carrier into the grooves 381, 3811, fixed cards 392, 393 are arranged at ends of the grooves. In a location where the fixed cards and a base bracket of the piercing element extend along the inclined plane 387, accordingly, the inclined plane 388 also extends between the fixed card 393 and the base of the piercing element. Thus, when the piercing element pierces the liquid chamber or after the pierced base enters into the liquid chamber as a whole, liquid flows down along the pierced base; in this case, the treatment liquid flows into the grooves or the channels 381, 3811 respectively along the inclined plane; and if there is not necessarily a same amount of liquid on two sides of the pierced base, the liquid is balanced on the two sides of the pierced base through the groove 387, and evenly distributed in the two channels 381, 3811. In some embodiments, a hole 391 is provided in a side wall 305 of the testing chamber; and a piston or a sealing plug 304 is arranged on the hole. After testing, samples for secondary validation test are taken through the hole 391.

### Cover Body Including Sample Chamber and Liquid Chamber

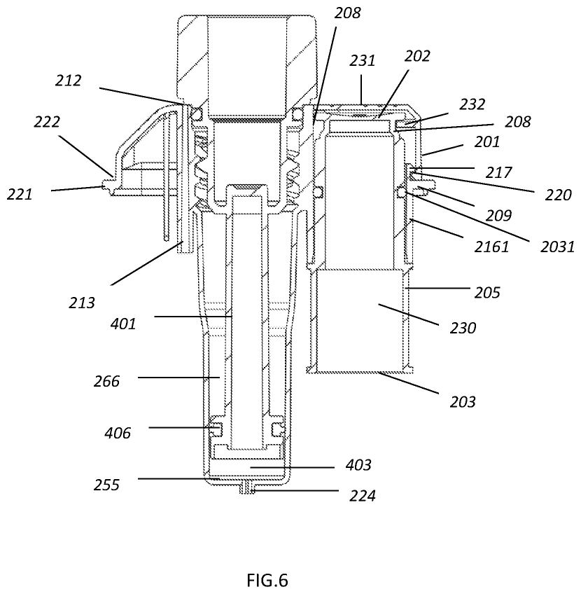

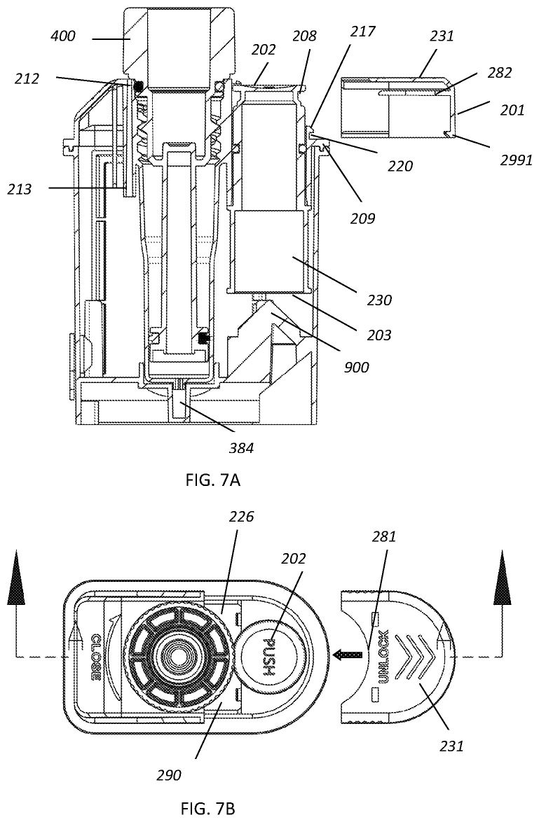

In some embodiments, the invention provides a cover body, and the cover body is configured to seal or cover the testing chamber, and the testing chamber has an immunoassay element. In some embodiments, the cover body includes a sample chamber for accommodating a sample collector and a liquid chamber containing a sample treatment liquid, the liquid chamber and the cover body are movably connected, or the liquid chamber and the cover body can move relative to the cover body, or the liquid chamber and the cover body are in the locking state and can move relative to the cover body after being unlocked. As shown in FIG. 5 and FIG. 6, the cover body has a front face 222, a back face 223, and a cover rim 221. The overall shape and size of the cover body are equivalent to these of the opening 306 of the testing chamber to be covered. When the cover body covers the opening 306 of the testing chamber, a part of the liquid chamber and the sample chamber are located in the testing chamber. In a specific embodiment of the invention, an opening of the testing is similar to a U-shape, and an overall shape of the cover body is also a U-shape fitting with the testing chamber. Thus, when the cover body covers the testing chamber, the covering direction thereof is unique, and errors during assembling are avoided; to be specific, when the cover body overlaps with the opening of the testing chamber, the cover body can correctly cover the opening; and if the covering direction is incorrect, the cover body is unable to cover the testing chamber.

In some embodiments, the cover body includes a sample chamber, where the sample chamber includes an opening 211 and a tube 225 extending along the opening, the tube includes a chamber 266, and the chamber is used to accommodate a sample collector 400. The sample chamber and the cover body are connected into an integral structure, the opening is arranged at the front face 222 of the cover body, and the tube extends towards the back face 223 of the cover body. When the cover body covers the testing chamber, the sample chamber is located in the testing chamber; specifically, the bottom of the sample chamber is located on the protruding faces385, 386 of the testing chamber, and the channel extending from the bottom is located in the channel 387 between the protruding tables. In some embodiments, the sample chamber has a bottom 255; the bottom is mainly allowed to be in contact with an absorption element 403 of a collector 400, and can absorb a liquid sample and can also be compressed. Thus, when the bottom 255 of the sample chamber is in contact with the absorption element, the absorption element can be compressed depending on the acting force of the bottom and the positional change of the collector in the sample chamber, thereby releasing the sample from the absorption element into the sample chamber. In some embodiments, a channel 224 is provided at the bottom of the sample chamber, the purpose of the channel is that after the absorption element 403 is squeezed to release the liquid sample, the liquid sample flows out along the channel 224 or directly flows into the testing chamber (if any). The collector is inserted from the opening 211 of the sample chamber, the opening is arranged on the cover body, and a rotary arrow symbol is provided near the opening of the sample chamber to indicate a rotation direction of the collector inserted into the sample chamber, for example, clockwise rotation or counterclockwise rotation. The collector 400 has a hand-held location 408 surrounded by a similarly protruding strip by one turn, and this is to increase the roughness of the hand-held location, thereby increasing hand-held friction. A lower end of the hand-held part of the collector is provided with an external thread, and the external thread fits with threads inside the sample chamber of the opening 211; through screw thread fit, the collector is allowed to be inserted into the liquid chamber and fixed thereon; and when the collector and the chamber are rotated and fixed relative to each other, the collector gradually enters the sample chamber. In this case, the absorption element 403 can be compressed, thereby releasing the liquid sample. In some embodiments, the collector has an annular groove 405 at an upper end of the absorption element, and an elastic sealing ring 406 is arranged in the groove. When the collector is inserted into the sample chamber 266, the annular sealing ring 406 is in seal fit with an inner wall 229 of the sample chamber; thus, when the absorption element 403 is squeezed or compressed, the liquid sample is allowed to flow out through the channel 224 at the bottom 255 of the sample chamber as much as possible, thereby preventing the liquid sample from flowing into the sample chamber defined by the sealing ring 406 and the thread.

Of course, if the cover body and the testing chamber are assembled together, the opening of the testing chamber is typically sealed by the cover body such that a sealing space is formed inside the testing chamber. If the collector is also sealed with the sample chamber, the testing chamber has an increased air pressure, which is not conducive to the liquid sample flowing into the testing chamber. Therefore, in some embodiments, the testing chamber is communicated with outer atmosphere through other structural designs; in absence of air pressure, the liquid can normally flow along the gravity direction. Therefore, a through hole 212 is further provided in the cover body and includes a channel 213 extending downward, the channel extends into the testing chamber and is mainly to keep the testing chamber communicate with outer atmosphere, such that the internal atmospheric pressure of the testing chamber is equal to the external atmospheric pressure thereof, and in this case, the liquid is easy to flow from the sample chamber to the testing chamber.

In some embodiments, a liquid chamber is further provided on the cover body and contains a treatment liquid. Generally, the treatment liquid herein does not include analytes, but may include the following functional components, for example, after the treatment liquid is mixed with the liquid sample from the absorption element, the testing performance of the liquid sample on the testing element can be improved, such as reagent for adjusting PH, reagent for removing impurities such as proteins and saccharides, or some reagents for eluting and stabilizing the analyte. In addition, the treatment liquid is mixed with the liquid sample in time, increasing the total volume of the liquid. This is mainly because when an amount of the sample absorbed by the absorption element 403 is relatively small, it is desirable to test multiple indicators or multiple analytes at one time, thereby increasing the total volume of the liquid. However, an amount of the liquid collected by the collector is insufficient. For example, the test device of the invention includes two carrier elements, each of the carrier elements includes 8 test strips, totaling 16 test strips; the test strips can substantially test 16 analytes, enough liquid needs to be provided for each of the test strips to complete the whole flow so as to obtain effective test results. For example, from a sample application area to a water absorption area, 20 μL liquid is needed for each test strip, while at least 320 μL liquid is needed for 16 test strips. However, if an amount of liquid compressed from the absorption element is only 300 μL, the amount of liquid reaching the test strip is at most 300 μL with the flow loss and is not enough to meet the required amount in the entire flowing process of the liquid for the test strips, which may lead to test failure. In this case, the treatment liquid in the liquid chamber is allowed to be released and mixed with the liquid sample, increasing the volume of the liquid, thereby ensuring that the whole test can be achieved and ensuring that the amount of the liquid is at least sufficient. Additionally, the treatment liquid is to dissolve the analyte. For example, when the testing element is performed for immunoassay, it is enough to achieve the immunoassay for the liquid chamber squeezed on the absorption element 403. However, if secondary testing is needed, the entire test device needs to be transported to a more advanced laboratory for validation test through a more precise test device, for example, liquid chromatography, meteorological or mass spectrometry device. However, the most common is that during transportation, the rise of ambient temperature causes water in the liquid sample in the testing chamber to be volatilized or evaporated; sometimes, water is completely volatilized and no liquid exists, the analyte is precipitated at the bottom of the testing chamber and dry. In this case, it is impossible to perform secondary sampling and validation test. If the secondary testing is needed, the liquid sample in the testing chamber needs to be absorbed for testing, and the treatment liquid is released to the testing chamber; the treatment liquid is used to dissolve the dried sample such that the analyte in the dried sample can be dissolved again, thereby absorbing the liquid sample from the testing chamber for the secondary validation test. Initial test herein is achieved by immunoassay strips, but is not very accurate, especially for some ambiguous results required for further validation. In this case, it is necessary to deliver the liquid sample to professional laboratories for more precise test, further performing validation test, for example, mass spectrometry, liquid chromatography or liquid chromatography-mass spectrometry.

Therefore, the treatment liquid in the liquid chamber of the invention can be released at different times. Thus, the liquid sample is released according to the conventional operation, instead of being released automatically. However, initial release and mixing of the liquid sample need to be performed according to the amount thereof; or when the secondary validation test is needed after initial immunoassay, the analyte in the solution needs to be released again. This requires an operator to release the treatment liquid under different conditions, and therefore it is necessary to control the liquid chamber of the treatment liquid. Moreover, liquid in the liquid treatment chamber of the invention neither directly contact with the absorption element, nor elute the adsorbed substances on the absorption element, but serves as a supplementary liquid. If an amount of liquid is insufficient, the above liquid serves as a supplementary liquid; and if the liquid sample for the secondary validation test is evaporated to dryness, the above liquid is supplemented to the testing chamber to dissolve the dry analyte. Therefore, in some embodiments, a liquid chamber is further provided on the cover body; the liquid chamber and the cover body are kept at two different states, namely a fixed locking state and an unfixed locking state. In the fixed locking state, the liquid chamber remains fixed and is unable to be operated (for example, it is unable to be pushed or exposed), and the liquid sample is stored in the liquid chamber without being released. In the unlocking state, the liquid chamber is movable, so that the treatment liquid can be removed from the liquid chamber. In some embodiments, the cover body includes a docking area similar to a ship docking area, and the docking area includes the liquid sample chamber. In addition, a locking element is further provided in the docking area, and the liquid chamber is fixed in the docking area through the locking element. When the locking element is unlocked, the liquid chamber can depart from or move in the docking area. For example, as shown in FIG. 5 and FIG. 6, the docking area on the carrier is located next to the opening 211 of the sample chamber and is similar to a stepped pattern or a notch. When the locking element enters the docking area, the notch is covered. Viewed from the outside, it seems that the cover body is complete without any notch. The docking area allows the locking element to fix the liquid chamber at a fixed position to cover the liquid chamber, thereby preventing incorrect operation; when the treatment liquid needs to be released, the locking element is moved away to expose the liquid sample chamber, such that the liquid chamber can be operated, for example, releasing the liquid to the test chamber and mixing the liquid with the liquid sample in the testing chamber.

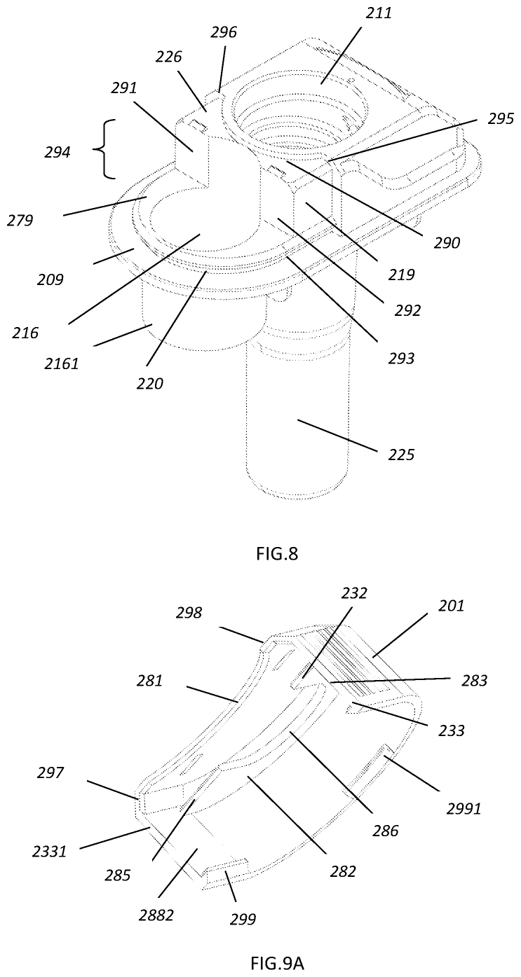

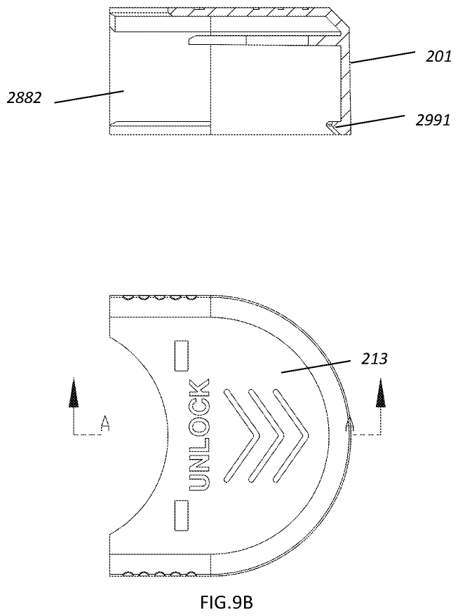

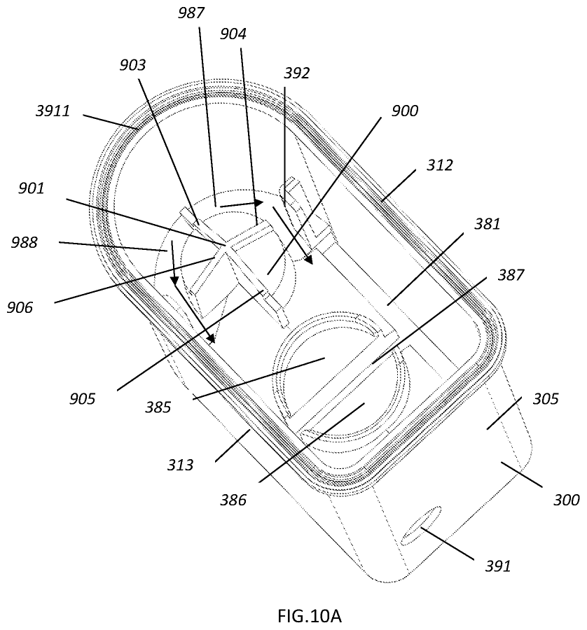

In some embodiments, the docking area includes a platform area 217, and an access area is arranged near the platform area and includes limit areas 290, 219, 226,218 arranged at two sides thereof. In a specific embodiment, the locking element can be fixed on the docking area in both the platform area and the access area, or the locking element can also be allowed to depart from the docking area. Any one of the platform area and the access area or both the platform area and the access area are arranged, such that the locking element is allowed to be fixed in the area and the liquid chamber is also fixed in the area through the locking element, and optionally, the liquid chamber is fixed and hidden in the area. Specifically, a hole 216 is provided in the platform area 217, allowing the liquid chamber to protrude from the hole. In presence of the hole 216, the platform area is divided into an area including the hole and the platform area 217 surrounding the hole. The platform area includes an extension area 209 where the platform area 217 is arranged in a stepped form; the extension area is also a part of the cover body and is a curved area as a whole; in addition, the extension area 209 fits with a partial area of the opening of the testing chamber, and the partial area 3911 of the opening of the testing chamber is curved, so the extension area is curved. A clamping slot 220 is formed between the platform area 217 and the extension area 209. It can be seen from FIG. 5 that the platform area 217 partially extends to the extension area 209 and a slot structure is formed within a distance between the areas 217, 209, and the slot structure fits with cards of protruding ribs 282, 2991, 233 of the locking element, such that the locking element is fixed onto the docking area. Specifically, the clamping slot 220 is at an arc position, and some clamping grooves are distributed on two sides 293, 2931 of the cover body, and the clamping slots thereon fit with the protruding ribs 299, 233 on the locking element. One way is to allow the locking element to enter the docking area through the clamping slot in a way similar to a sliding rail and a chute, and the clamping slot 220 fits with the protruding rib 2991, such that the locking element is fixed onto the docking area 294 on the cover body. In a specific embodiment, for example, the locking element as shown in FIG. 9 includes a three-dimensional semi-circular structure; the structure includes a main structure; the main structure includes a top area 231, a bottom area 299, and a cross section 201 connecting to the top area 231 and the bottom area; a semi-circular notch 281 is formed in the top area; and a semi-circular card 282 is arranged between the top area and the bottom area and has a notch 286 to form a structure similar to a snap ring. The size of the notch matches with the size of a neck 208 formed between the pressing portion 202 of the liquid chamber (namely, the top of the liquid chamber) and the main body 205 of the liquid chamber, such that the notch of the card enters the top 208 of the liquid chamber, and the neck is located at the fixed position of the locking element without normally falling off from the cover body, or the liquid chamber is at the high position. In fact, the neck herein has an annular groove 208 between the pressing portion 202 and the main body 205 of the liquid chamber, and the notch 286 of the card can be clamped around the groove 208, and the card has a specific width, such that the pressing portion is located on the card, and the liquid chamber is at the fixed high position. The annular card or snap ring has two end portions 285, 232. It can be seen from FIG. 8 combined with FIG. 6 that the access area of the docking area is in contact with vertical faces 291, 292 of the plane and two end portions 285, 232 of the snap ring, thereby limiting the lateral movement distance of the locking element. For example, the locking element enters the docking area along the direction as indicated by an arrow in FIG. 7. In some embodiments, the card 282 is arranged in the space formed between the top area 231 of the locking element and the bottom area 299 thereof; for example, the end portions 285, 232 of the card are both retracted inside an edge formed by the notch in the top area 231, that is, a projection area of the card on the top area 231 is located in the top area 231. Although the notch is also provided in the top area, the top area 231 covers the entire pressing portion 202 of the liquid chamber, such that the liquid chamber is hidden in the docking area. In addition, the notch 281 is provided in the top area and similar to an arc notch, and fits with an area formed by the limit areas 266, 290 of the access area and the opening 211 of the liquid chamber to cover the entire upper part of the liquid chamber; the entire locking element is semicircular, and left and right areas of the docking area are also covered by the locking element, such that the entire liquid chamber exposed in the docking area is wrapped and hidden. In fact, the bottom area 299 of the locking element is defective or absent. One or more ribs or cards 233, 282, 2991 extending inward are arranged inward at the bottom edge of the cross section 201, and these ribs extending inward fit with the clamping slots 220, 293, 2931 formed between the platform area 217 and the extension area 209, thereby limiting the longitudinal position of the locking element in the docking area. A distance between the ribs or the cards 233, 282, 2991 and the card 282 with a notch is equal to that between the neck 208 of the liquid chamber and the platform area 217; thus, when the locking element enters the docking area, the liquid chamber is allowed to be at an initial first position (as shown in FIG. 5). When the locking element departures from the docking area, the liquid chamber is allowed to be at a free state and can be pressurized to move from top to bottom in the longitudinal direction, the neck 208 can be allowed to move to the plane 217, or the neck with the pressing portion 202 can be allowed to pass through the hole 216 and move in the direction distal to the cover body. In order to allow the locking element to be better fixed on the docking area, two face-to-face surfaces 2882, 283 are formed on the cross section 201, and are in contact with the limit areas 219, 218 of the access area of the docking area, such that the locking element is fixed onto the docking area, limiting left and right positions of the locking element. Similarly, the notch 281 of the top area 231 fits with the area formed by the limit areas 290, 226 and the opening of the sample chamber, such that the top of the notch 281 is in contact with the limit areas 219, 226. When the cross section 201 is solid and not hollowed out, the locking element can be allowed to cover the entire docking area, and the liquid cavity can be allowed to be hidden in the docking area. At the same time, the position of the liquid chamber is unable to be known from the outside, thus preventing some incorrect operations (as shown in FIG. 3). Only when the locking structure departures from the docking area, the position of the liquid chamber can be exposed (as shown in FIG. 5, FIG. 12, and FIG. 15). Some arrow indications are provided on the top of the locking structure, indicating that when the liquid chamber needs to be enabled, how the locking structure is detached from the docking area and how the liquid chamber is in the unlocking state. In other words, the locking element enters the initial state of the docking area, such that the liquid chamber is in the fixed state; in this case, the liquid chamber is at the high position (FIG. 12). When the locking element departures from the docking area, the liquid sample is allowed to be in a free or movable state, such that the liquid chamber can move and is likely to release the liquid. In some embodiments, an outer wall of the liquid chamber, near a lower part of the pressing portion 202, is provided with some protruding ribs; the surfaces of the protruding ribs are in contact with a hole 206 in the platform 217, allowing a gap between the liquid chamber and the hole; the protruding ribs are mainly to increase friction between the liquid chamber and the inner surface of the hole; after the locking element departures from the liquid chamber, the liquid chamber is substantially kept at the initial high position, instead of freely falling off from the plane area. Additionally, the gap is to keep the testing chamber communicate with the outside. Although the locking structure covers the docking area, some small holes can be provided in the top area 231 of the locking structure; the interior of the testing chamber is allowed to communicate with the outside through the gap or by contacting a mechanical gap between the locking structure and the docking area. Thus, when the liquid chamber enters the testing chamber from a high position, gas beyond the volume occupied by the liquid chamber can be removed from the gap. Of course, such gas can also be removed from a gas channel 213. Of course, the gap may be also absent. As shown in FIG. 6, the liquid chamber 205 is in sealing fit with an inner wall of an extension pipe 2161 of the hole 216 in the docking area of the cover body, and an outer wall of the liquid chamber is in sealing with a sealing ring 2031 to seal the inner wall of the extension pipe, and a balance between the interior of the testing chamber and the outer atmosphere is kept through a vent hole 210 and a pipe 213 extending to the testing chamber.

FIG. 3 is a three-dimensional schematic diagram of a test device completely assembled according to the invention; FIG. 12 is a schematic diagram showing a cross-sectional structure with a locking element removed, it can be seen from this figure that the sample chamber and the liquid chamber are both located in the testing chamber; FIG. 12 shows that the collector is inserted into the sample chamber and the liquid sample is released into the testing chamber; in this case, it is desired to release the treatment liquid in the liquid chamber, so the locking element is allowed to depart from the docking area to expose the liquid chamber at the high position, where the liquid chamber is movable. The liquid chamber contains the treatment liquid, and the bottom thereof is sealed by a sealing film; in the testing chamber, the liquid chamber is located above the piercing element. When the liquid chamber is pushed down from the high position to the low position (FIG. 15), the liquid chamber is pierced by the piercing element located in the testing chamber, and the treatment liquid therein is released to the testing chamber and then mixed with the liquid sample released by the absorption element on the collector, thereby completing normal test

Therefore, in terms of an operation method, the three-dimensional assembly diagram as shown in FIG. 3 is provided. In this case, the collector is packaged individually, instead of being located in the sample chamber. When the collector 400 is required for detection of the liquid sample, the absorption element thereof is inserted into the mouth to absorb saliva samples. After the absorption element 403 absorbs the samples, the collector is inserted into the sample chamber 225, and threads on the collector rotatably fit with those in the opening 211 of the sample chamber to allow the absorption element of the collector to be in contact with the bottom 255 of the sample chamber; the collector moves down in the sample chamber as a whole with rotation thereof in the sample chamber to squeeze the absorption element 403, thereby releasing the liquid sample from the absorption element 403 squeezed. The absorption element herein is made of any water absorbent material, for example, filter paper, fiber, sponge, degreasing sponge, degreasing resin, polyester material, and other water absorbent materials. Some materials are hard in dry conditions and become soft after absorbing water. Softened material can be compressed to release the liquid sample. The liquid sample released through compression flows into the channel 387 through the channel 224 at the bottom of the sample chamber; then the liquid sample flowing into the channel 387 flows respectively to channels 381, 3881 on two sides and contacts the testing element. When it is found that the required amount of liquid for all test strips may be not achieved in case of a relatively small amount of the liquid on the collector, the locking element is allowed to depart from the cover body to expose the liquid chamber (as shown in FIG. 12), and then the liquid chamber is pressed to move downward in the testing chamber, such that the piercing element 900 located at the bottom of the testing chamber pierces the sealing film at the bottom of the liquid chamber, thereby allowing the treatment liquid therein to flow to the test chamber. Because a common testing chamber is transparent, it is possible to observe whether the liquid sample is sufficient or not through the side wall of the testing chamber. If the liquid sample is insufficient, the locking element is enabled and departs from the cover body to expose the liquid chamber for subsequent operations.

If the liquid sample is sufficient and can achieve the flow test of the immunoassay strip, the liquid chamber is not enabled and continues to be hidden, and the locking element also does not depart from the docking area on the cover body. After the initial test, when it is suspected that test results are undetermined or results displayed on a T line of a test strip are unable to be correctly judged, for example, when it is not determined that the test results are positive or negative, it is desired that the sample is delivered to a more professional laboratory for secondary validation test; when the laboratory performing a secondary test receives the sample, the sample is inserted into a liquid absorber through the hole 391 in the side wall to absorb it; if it is found that an amount of the sample is insufficient or there is no liquid sample, the liquid chamber is enabled, the locking element is allowed to depart from the cover body to expose the liquid chamber, and the pressing portion 202 of the liquid chamber is forcibly pushed, such that the liquid chamber moves from the high position to the low position, and a piercing structure in the testing chamber pierces the liquid chamber to release the treatment liquid to the testing chamber so as to dissolve the dry sample or increase the sample volume. Generally, the volume of the treatment liquid in the liquid chamber is constant, such as 1 ml, 2 ml, 3 ml, 4 ml, and 5 ml. Thus, the volume of the treatment liquid can be known in advance; and when the liquid sample is insufficient and the volume of the treatment liquid released can be known, such that the dilution rate of the liquid sample can be simply converted. In some embodiments, more than two liquid chambers are provided in the docking area; the arrangement of the liquid chamber is the same as that in the above specific embodiment, for example, two holes are provided in the plane 217 of the docking area and respectively provided with a liquid chamber, and two parallel piercing elements are arranged in the testing chamber; each liquid chamber is locked by the locking element; when unlocked, the two liquid chambers can be pushed to be pierced by the piercing element in the testing chamber. The arrangement of two liquid chambers is to give operators more choices. For example, one of the liquid chambers is filled with a treatment liquid to adjust the PH value of the liquid sample, and the other thereof is filled with a treatment liquid to dilute the sample and remove large particles in the liquid sample. The operators can make targeted choices according to the characteristics of samples. Of course, the liquid chamber is at a low position after operated, but the locking element can still enter the docking area, covering the entire docking area and allowing the liquid chamber to be at a hidden position again, which maintains the integrity or other incorrect operations of the test device.

All the patents and publications mentioned in the description of the invention indicate that these are public technologies in the art and can be used by the invention. All the patents and publications cited herein are listed in the references, just as each publication is specifically referenced separately. The invention described herein can be realized in the absence of any one element or multiple elements, one restriction or multiple restrictions, where such restriction is not specifically described here. For example, the terms “comprising”, “essentially consisting of” and “consisting of” in each embodiment herein may be replaced by the rest 2 terms. The so-called “a/an” herein merely means “one”, but does not exclude including 2 or more instead of including only one. The terms and expressions which have been employed herein are descriptive rather than restrictive, and there is no intention to suggest that these terms and expressions in this description exclude any equivalents, but it is to be understood that any appropriate changes or modifications can be made within the scope of the invention and appended claims. It can be understood that the embodiments described in the invention are some preferred embodiments and features. A person skilled in the art can make some modifications and changes according to the essence of the description of the invention. These modifications and changes are also considered to fall within the scope of the invention and the scope limited by independent claims and dependent claims.

1. A device for testing an analyte in a liquid sample, comprising a cover body, wherein the cover body comprises a sample chamber for accommodating a sample collector and a liquid chamber containing a sample treatment liquid.

2. The device according to claim 1, wherein the liquid chamber containing a sample treatment liquid is movable relative to the cover body.

3. The device according to claim 2, wherein the liquid chamber comprises a first locking position and a second unlocking position relative to the cover body.

4. The device according to claim 3, wherein when the liquid chamber is located at the first locking position, liquid in the liquid chamber is not released; and when the liquid chamber is located at the second unlocking position, the liquid in the liquid chamber is capable of being released.

5. The device according to claim 3, wherein the liquid chamber is located at a locking position and locked on the cover body by a locking element.

6. The device according to claim 5, wherein the locking element comprises a limiting structure capable of limiting movement of the liquid chamber; and when the limiting structure is detached from the liquid chamber, the liquid chamber changes from a locking state to an unlocking state.

7. The device according to claim 6, wherein the liquid chamber in the unlocking state is movable relative to the cover body.

8. The device according to claim 7, wherein the movement comprises longitudinal movement from a high position to a low position relative to the cover body.

9. The device according to claim 8, wherein the liquid chamber comprises a sealing film easy to pierce; and when the liquid chamber moves downward relative to the sealing film, the sealing film is pierced by a piercing element, whereby releasing the liquid in the liquid chamber.

10. The device according to claim 5, wherein the cover body comprises a docking area, the liquid chamber is located in the docking area, and a locking element is located in the docking area, such that the liquid chamber is located at a fixed locking position.

11. The device according to claim 10, wherein the locking element is located in the docking area such that the liquid chamber is hidden in the docking area; and after the locking element departs from the docking area, the liquid chamber is exposed.

12. The device according to claim 10, wherein the docking area comprises a platform, a hole being provided in the platform; and the liquid chamber penetrates through the hole and is located at a high position distal to the platform; and the high position distal to the platform is locked by the locking element.

13. The device according to claim 12, wherein when the locking element is away from or detached from the docking area, the liquid chamber is capable of moving from the high position distal to the platform to a low position proximal to the platform.

14. The device according to claim 1, wherein a channel is provided in the sample chamber; when the sample collector is inserted into the channel of the sample chamber, an absorption element of the sample collector is squeezed, whereby releasing the liquid sample into the sample chamber; and then the liquid flows out of the sample chamber along the channel.

15. The device according to claim 7, wherein the device further comprises a testing chamber having a testing element, the cover body covers an opening of the testing chamber, and the sample chamber and the liquid chamber are located in the testing chamber.

16. The device according to claim 1, wherein the sample chamber and the liquid chamber extend outward from the cover body in a same direction.

17. The device according to claim 15, wherein the testing chamber comprises a piercing element capable of piercing the liquid chamber; and when the liquid chamber moves inward the testing chamber relative to the cover body, the piercing element pierces the liquid chamber and enters therein, such that the liquid in the liquid chamber is forced to flow into the testing chamber.

18. The device according to claim 17, wherein the piercing element is provided with a sharp piercing needle and a base connected with the piercing needle, and a diameter of the base is equivalent to that of the liquid chamber.

19. The device according to claim 15, wherein the testing chamber comprises a carrier for carrying the testing element, and the carrier is provided with a groove for fixing the testing element.

20. The device according to claim 19, wherein a hole communicating with atmosphere is provided in the cover body, and a channel extending towards the testing chamber is provided in the hole.
